(19) United States
(12) Patent Application Publication
(10) Pub. No.: US 2025/0351175 A1
(43) Pub. Date: Nov. 13, 2025

(54) Coexistence Unavailability Indication in a Multi-user Transmission Opportunity

(71) Applicant: Apple Inc., Cupertino, CA (US)

(72) Inventors: Morteza Mehrnoush, Hayward, CA (US); Abdel Karim Ajami, Cupertino, CA (US); Zhou Lan, San Jose, CA (US); Qi Wang, Mountain View, CA (US); Mohamed Abouelseoud, Burlingame, CA (US); Yong Liu, Campbell, CA (US); Anuj Batra, Redwood City, CA (US)

(21) Appl. No.: 18/961,872

(22) Filed: Nov. 27, 2024

Related U.S. Application Data
(60) Provisional application No. 63/645,707, filed on May 10, 2024.

(51) Int. Cl. H04W 74/0816; H04W 28/02; H04W 76/15

(52) U.S. Cl. CPC H04W 74/0816; H04W 28/0278; H04W 76/15

(57) ABSTRACT

Methods, systems and devices for transmitting unavailability information in a wireless local area network. A wireless device establishes first and second wireless connections using a first set of radio resources. The wireless devices receives a multi-user initial control frame (ICF) from a wireless access point over the first wireless connection. Based on receiving the multi-user ICF, the wireless device transmits a control response message to the wireless access point that indicates unavailability information for the wireless device.

### PRIORITY INFORMATION

The present application claims priority to Provisional Patent Application No. 63/645,707, titled “Coexistence Unavailability Indication in a Multi-user Transmission Opportunity” and filed on May 10, 2024, which is hereby incorporated by reference in its entirety, as though completely and fully set forth herein.

### TECHNICAL FIELD

The present application relates to wireless communication, including techniques and devices for indicating unavailability due to coexistence events of Wi-Fi and other technology (for example, Bluetooth) in a wireless local area network architecture.

### DESCRIPTION OF THE RELATED ART

Mobile electronic devices, stations (STAs), or user equipment devices (UEs) may take the form of smart phones or tablets that a user typically carries. One aspect of wireless communication that may commonly be performed by mobile devices may include wireless networking, for example over a wireless local area network (WLAN), which may include devices that operate according to one or more communication standards in the IEEE 802.11 family of standards. Such communication can be performed in an infrastructure setting as well as in a peer-to-peer setting.

Additionally, wireless devices may commonly be capable of performing various other types of wireless communication, such as cellular communication (e.g., according to 3GPP cellular communication standards such as LTE and NR) and Bluetooth communication.

In some instances, it may be possible that multiple different wireless communication technologies or multiple interfaces for the same wireless communication technology in a wireless device time share at least some of the same radio resources. Managing such co-existence to reduce or avoid negative impacts from potential collisions, interference, unnecessary rate adaptation, and/or other possible outcomes may be a difficult challenge, with potential for new complications to arise as various wireless communication technologies evolve over time. Accordingly, improvements in the field are desired.

### SUMMARY

Embodiments are presented herein of, inter alia, systems, apparatuses, and methods for devices to transmit and receive unavailability announcements for co-existence and peer-to-peer management.

A wireless device may include one or more antennas, one or more radios operably coupled to the one or more antennas, and a processor operably coupled to the one or more radios. The wireless device may be configured to establish a connection with an access point through a wireless local area network (WLAN) over one or multiple wireless links, or it may be an access point configured to establish a connection with one or more other wireless devices through a WLAN over one or multiple wireless links. The wireless device may operate in each of the wireless links using a respective radio of the one or more radios.

According to the techniques described herein, the wireless device may establish multiple wireless connections that use a partially or fully shared set of radio resources. The wireless device may determine that it may or will be unavailable on one or more of those wireless connections during a future time period, for example due to scheduled communication activity or other co-existence considerations on another of those wireless connections (e.g. due to a coexistence event).

The wireless device may provide an indication of the future time period during which it has determined that it may or will be unavailable on one or more of those wireless connections to the communication partner(s) of the wireless device on the wireless connection(s).

In some embodiments, the wireless device receives a multi-user initial control frame (ICF) from a wireless access point over a first wireless connection and, based at least in part on receiving the multi-user ICF, transmits a control response message to the wireless access point. The control response message may indicate unavailability information for the wireless device related to the upcoming coexistence event.

Wireless devices receiving such an indication of a time period of future unavailability, and determining that the indication applies to them, may be able to avoid transmitting to the sender of the indication during the indicated time period of future unavailability, while at least potentially still being able to use those radio resources for other purposes during the indicated time period, such as for communications with other wireless devices. Thus, at least according to some embodiments, such announcements may help a wireless device reduce or avoid collisions on radio resources shared between multiple wireless connections by the wireless device with limited impact on use of those radio resources by other wireless devices in the vicinity.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIG. 5 is a flowchart diagram illustrating an example method for providing unavailability information in a wireless local area network, according to some embodiments;

FIG. 6 illustrates an example coexistence indication causing conflict between an EHT STA and an UHR STA, according to some embodiments;

FIG. 7 illustrates an example method to enhance the MU-RTS by utilizing the duration field to handle coexistence issues, according to some embodiments;

FIG. 8 illustrates an example method to improve protection for coexistence scenarios, according to some embodiments;

FIG. 9 illustrates an example multi-user (MU) scenario in which a UHR STA refrains from transmitting a CTS message to implicitly indicate an upcoming coexistence event, according to some embodiments;

FIG. 10 illustrates an example method for using the BSR Control in the QoS-Null frame to send TB PPDU as a response to BSRP trigger frame, according to some embodiments;

FIG. 11 illustrates an example of bit allocation for utilizing the A-Control subfield to communicate a full unavailability profile and PBT control, according to some embodiments;

FIGS. 12A-B illustrate example options for utilizing BSR Control in QoS-Null that is aggregated with ACK/BA, according to some embodiments;

FIG. 13 illustrates an example method for including the unavailability profile in CR/BA, according to some embodiments; and

FIG. 14 illustrates an example comparison of overhead for different probe-before-talk (PBT) control frame implementations, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

The following is a list of acronyms used in this disclosure:
UE—User Equipment
AP—Access Point
UHR—ultra-high reliability
HE—High Efficiency
HT—High Throughput
EHT—Extremely High Throughput
MU—multi-user
MU—RTS-Multi-user Request to Send
MU—CTS-Multi-user Clear to Send
MU-BA—Multi-user Block Acknowledgment Request
BSRP—Buffer Status Report Poll
TXOP—Transmission Opportunity
SIFS—Short Interframe Space
L-SIG—Legacy Signal
EIFS—extended inter-frame space
ICF—Initial Control Frame
ICR—Initial Control Response
EMLSR—enhanced multi-link single radio
BA—block acknowledgment
NAV—network allocation vector
PPDU—Physical Layer Protocol Data Unit
TB—Trigger-Based
QOS—Quality of Service
QN—QoS-Null

### Terminology

The following are definitions of terms used in this disclosure:

Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile), or can be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

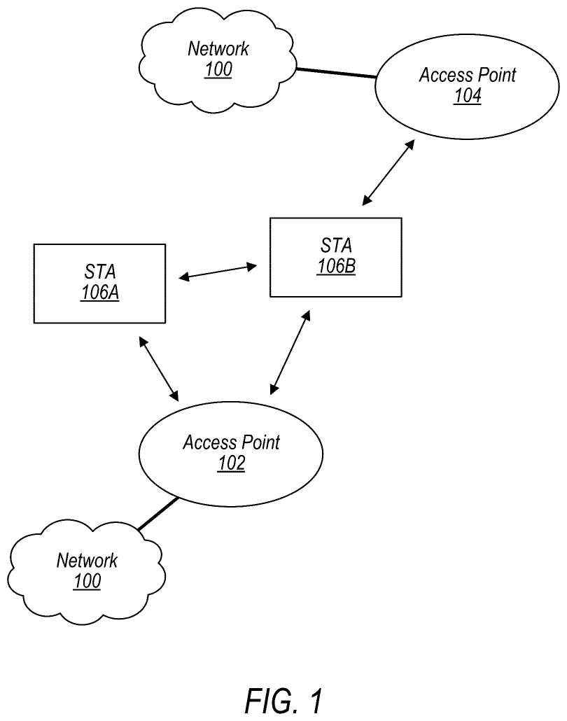

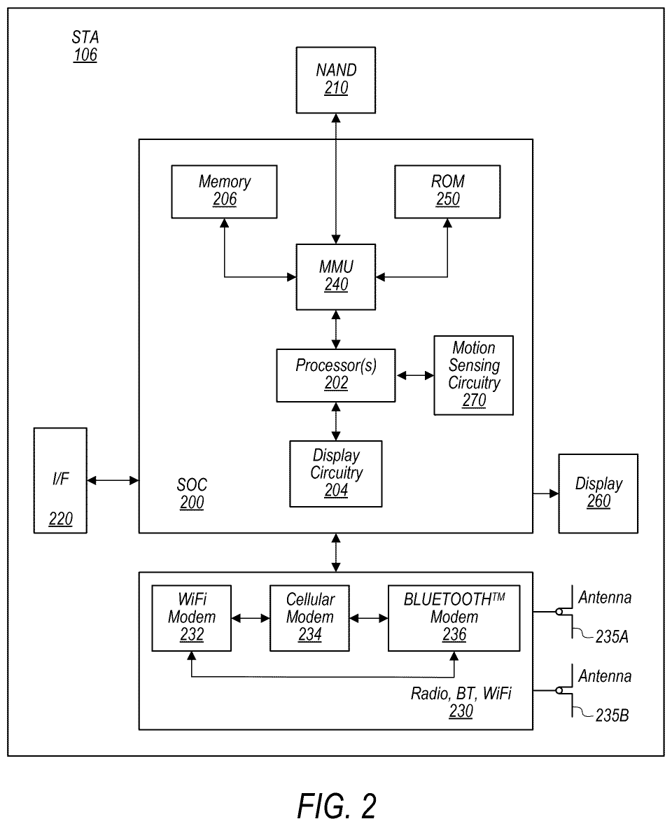

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), Bluetooth, etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for transmitting unavailability information in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the transmitting unavailability information described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

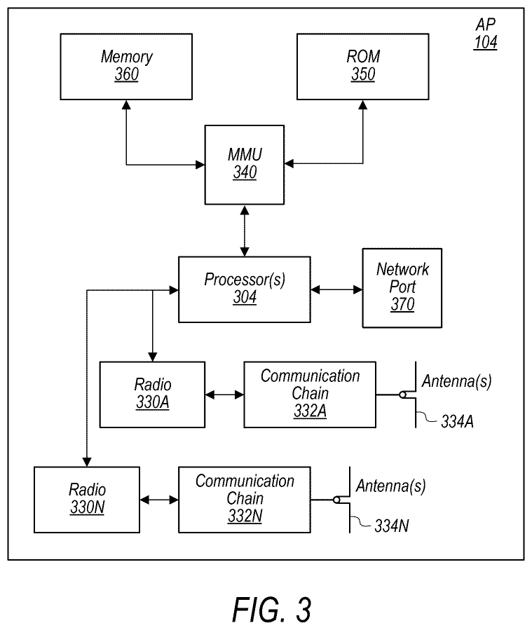

### FIG. 3—Block Diagram of an Access Point

FIG. 3 illustrates an example block diagram of an access point (AP) 104. In some instances (e.g., in an 802.11 communication context), the AP 104 can also be referred to as a station (STA) and/or an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as receiving unavailability information, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

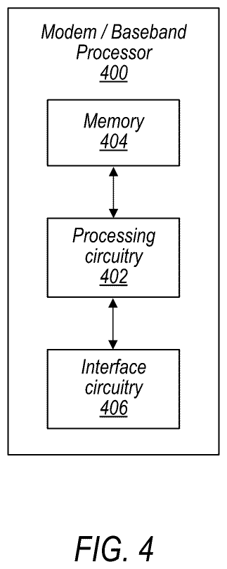

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as transmitting and receiving unavailability information, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

### Mitigation of Coexistence Events

In wireless communication, it can occur that a wireless device can communicate on multiple wireless connections using partially or fully shared radio resources, for example if multiple Wi-Fi connections (e.g., an infrastructure Wi-Fi link with an access point wireless device and a peer-to-peer Wi-Fi link with a non-access point wireless device) are established, or if multiple connections are established according to different wireless communication technologies (e.g., Wi-Fi and Bluetooth, Wi-Fi and 3GPP 5G NR, etc.), it could occur that a wireless device time-shares one or more radio resources that are common to different connections. The wireless device also may implement one or more coexistence techniques to mitigate interference, e.g., so that a transmission does not interfere with a concurrent reception.

Managing such multiple connections may be important, for example in order to prevent or reduce the likelihood of collisions occurring between transmissions by communication partners that may not otherwise be aware that the communication (e.g., transmission and/or reception) on their connections with the wireless device are concurrent with communication (e.g., transmission and/or reception) on other wireless connections by the wireless device. In addition to the direct benefits of reducing or avoiding such collisions (or interference), such as reducing or avoiding potential packet loss that could result from such collisions, this may also help reduce or prevent rate adaptation and/or other interference mitigation techniques (that otherwise are not needed for some channel conditions) from being enabled, which may improve overall link use efficiency.

One possible set of techniques for managing multiple wireless connections of a wireless device that share radio resources may include a set of techniques for supporting transmission and reception of unavailability information for a wireless device, for example to help inform some or all of the wireless device's communication partners of upcoming periods of time during which the wireless device will be unavailable to them on a given set of radio resources.

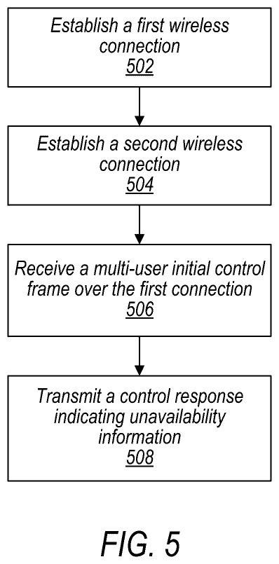

### FIG. 5—Transmission of Unavailability Information Flowchart

FIG. 5 is a flowchart diagram illustrating an example method for supporting transmission of unavailability information in a WLAN, according to some embodiments. In various embodiments, the elements of the methods shown can be performed concurrently, in a different order than shown, can be substituted for by one or more other method elements, or can be omitted. Additional method elements can also be performed as desired.

Aspects of the method of FIG. 5 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements. As illustrated, the method may proceed as follows:

At 502, a wireless device establishes a first wireless connection using a first radio resource or set of radio resources. The first wireless connection may utilize any of a variety of radio access technologies (RATs), such as WLAN, Bluetooth or a cellular RAT such as 5G NR. The first wireless connection may be made with a wireless access point (AP), in some embodiments.

At 504, the wireless device establishes a second wireless connection using, at least partially, the first radio resource or set of radio resources. The second wireless connection may utilize any of a variety of radio access technologies (RATs), such as WLAN, Bluetooth or a cellular RAT such as 5G NR. Notably, the first and second wireless connection may share at least some radio resources (e.g., the “first set” of radio resources), such that coexistence events may potentially arise between the first and second wireless connections.

The first and second wireless connections may include associations established using Wi-Fi, wireless communication techniques that are based at least part on Wi-Fi, and/or any of various other wireless communication technologies, including any mix of different communication technologies, according to various embodiments. In some embodiments, the first and/or second wireless connections may include an infrastructure Wi-Fi connection. For example, a wireless AP may provide beacon transmissions including information for associating with the wireless AP, and one or more other wireless devices (e.g., non-AP wireless devices, which could include the wireless device) may request to associate with the wireless AP using the information provided in the beacon transmissions, as one possibility. In some embodiments, the first and/or second wireless connections may include a peer-to-peer (P2P) Wi-Fi connection, or a non-Wi-Fi connection such as a Bluetooth connection. For example, the wireless device may form a Wi-Fi connection with an AP as the first wireless connection, and a P2P Wi-Fi connection with another non-AP wireless device as the second wireless connection, as one possibility. As another example, the first wireless connection may be a Wi-Fi connection (infrastructure or P2P), and the wireless device may form a Bluetooth wireless connection with a paired Bluetooth device as the second wireless connection, or with another wireless device according to another wireless communication technology, as further possibilities.

Variations and/or other techniques for establishing an association are also possible. In some embodiments, it may be possible that the multiple wireless connections established by the wireless device using the first set of radio resources could include more than two wireless connections. Note also that the radio resources shared by the multiple wireless connections may include part or all of the spectrum portions used by each of the wireless connections, according to various embodiments; in other words, the radio resources of the multiple wireless connections may be partially overlapping, or may be fully overlapping, in various instances. In some instances, the wireless device may additionally have one or more wireless connections that use radio resources that do not overlap with the first set of radio resources.

At 506, the wireless device receives a multi-user initial control frame (ICF) from a wireless access point over the first wireless connection. The multi-user ICF may be a customized frame that is intended for use within a multi-user wireless communication scenario, various embodiments of which are described in greater detail below.

At 508, based at least in part on receiving the multi-user ICF, the wireless device transmits a control response message to the wireless access point. The control response message indicates unavailability information for the wireless device. The control response message may be sent a short interframe space (SIFS) after receiving the multi-user ICF, in some embodiments.

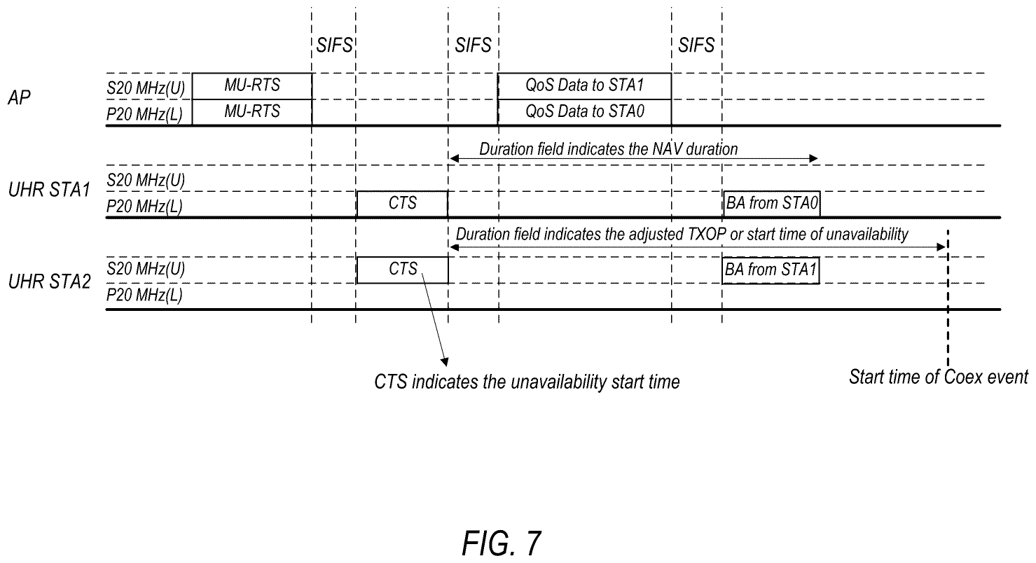

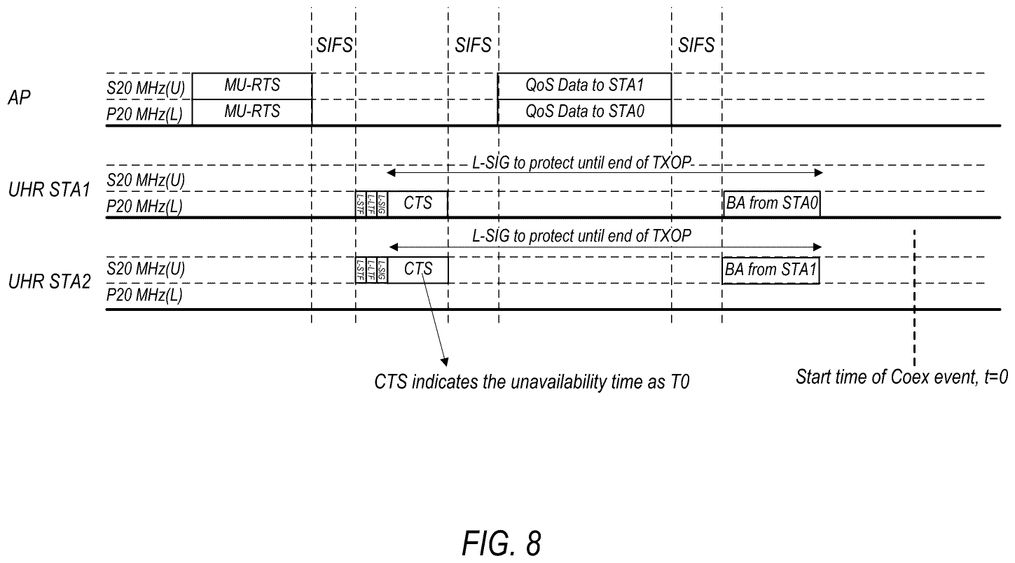

In some embodiments, the multi-user ICF is a multi-user request-to-send (MU-RTS), and the control response message is a clear-to-send (CTS) message. Example communication flow diagrams illustrating embodiments using an MU-RTS/CTS exchange to convey unavailability information are shown in FIGS. 7 and 8. As shown in FIGS. 7 and 8, the AP transmits to MU-RTS messages on two frequency bands (the “primary” band P20 and the “secondary” band S20) to two respective ultrahigh reliability (UHR) stations (STA), UHR STA1 and UHR STA 2.

In some embodiments, the control response message is a clear-to-send message. As shown in FIG. 7, the two UHR STAs respond to the MU-RTS message with respective CTS messages on the two frequency bands. The CTS messages include a duration field to indicate a NAV duration, an adjusted transmission opportunity (TXOP) duration, or the start time of unavailability. In some embodiments, as shown in FIG. 8, the wireless device may transmit a legacy signal (L-SIG) message including a duration field to indicate the TXOP duration. The indicated TXOP duration may indicate the start of the unavailability start time. In some embodiments, both the L-SIG and the CTS message may indicate the unavailability start time. The control response message and the L-SIG message may both be transmitted within a single Physical Layer Convergence Protocol (PLCP) Protocol Data Unit (PPDU).

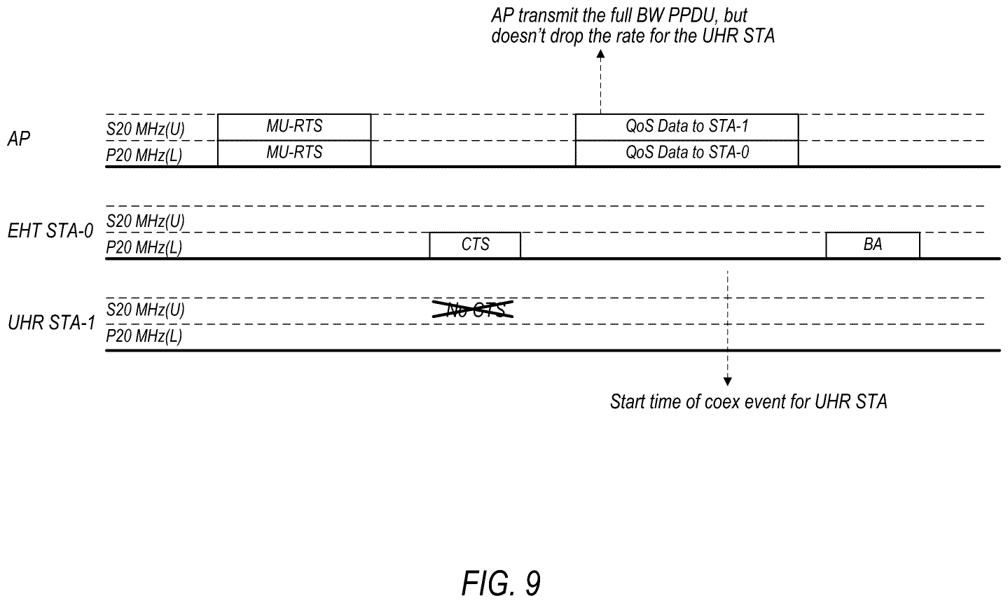

In some embodiments, the multi-user ICF is a Buffer Status Report Poll (BSRP) message, and the control response message is a quality-of-service (QOS) null frame. Example communication flow diagrams illustrating embodiments using BSRP/QOS null frame exchange to convey unavailability information are shown in FIGS. 9, 11 and 13.

In various embodiments, the unavailability information may be indicated within an A-Control field within the QoS null frame, or it may be indicated within a probe-before-talk (PBT) control frame. When the unavailability information is indicated within a PBT frame, it may be a full PBT control frame, or a variable length PBT control frame, in various embodiments. A variable length PBT control frame may modify the size of the control frame depending on the number and potentially other aspects of the future unavailability event(s). The unavailability information carried in the PBT frame may be a “light” unavailability profile that includes a limited amount of information (e.g., it may contain a link identifier for the future unavailability event, the future unavailability start time, and the minimum future unavailability duration, as illustrated in the example frame structure shown in FIG. 11), or a “full” unavailability profile that also includes a full bitmap indicating which ones of a plurality of links are involved in one or more future unavailability events.

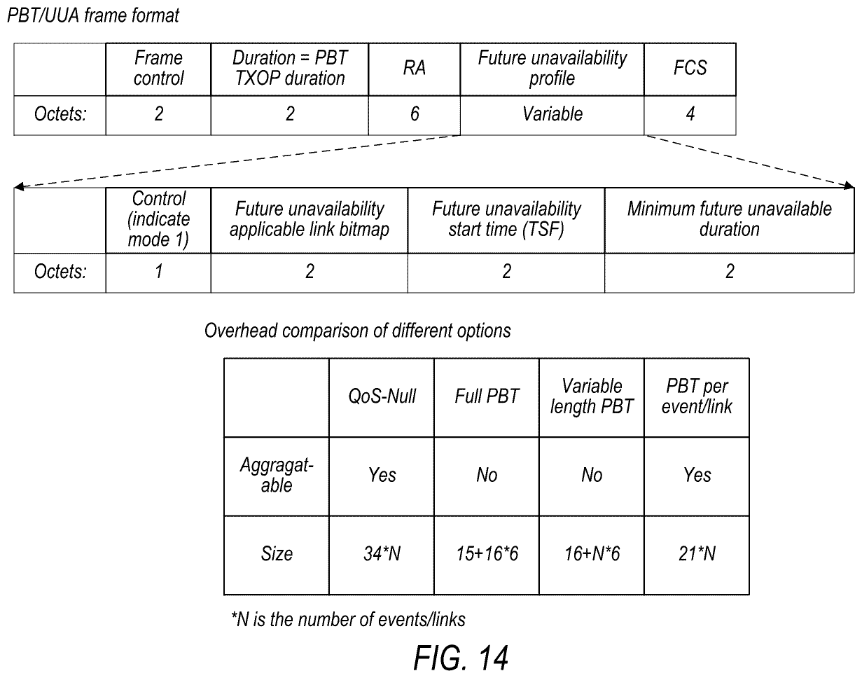

In some embodiments, the unavailability information is included in a block acknowledgment frame. An example of this embodiment is shown in FIG. 14. As illustrated, a coexistence arbitrator may determine at the indicated time that an upcoming coexistence event will occur. This determination is made after the UHR STA has sent a BSR in response to the BSRP, such that the UHR STA may not be able to use the BSR to communicate unavailability information, in this example. To accommodate this circumstance, in response to a multi-user block acknowledgment request (MU-BAR) received from the AP, the UHR STA may include a PBT with a block acknowledgment (BA) frame and may include the unavailability information within the PBT.

In some embodiments, the unavailability information indicates a first time period of future unavailability for the wireless device on the first set of radio resources. The first time period of future unavailability for the wireless device on the first set of radio resources may be determined by the wireless device based at least in part on a time sharing configuration of the first set of radio resources by the wireless device between the first wireless connection and the second wireless connection, or more generally between any of the multiple wireless connections between which the wireless device is dynamically time-sharing the first set of radio resources. For example, the wireless device may determine that due to scheduling or other co-existence considerations on one of the wireless connections that time-share the first set of radio resources, the wireless device will be unavailable on another of the wireless connections that time-share the first set of radio resources during a certain time period, which time period may thus be determined as the first time period of future unavailability.

In some embodiments, the indication of the time period of future unavailability includes a future unavailability start time, a minimum future unavailability duration, and/or a bitmap indicating one or more links involved in the future unavailability event. In some embodiments, a duration field in the control response message may be used to indicate the unavailability start time. The future unavailability start time value may be indicated as an offset from an end of the time period of current availability for the wireless device, as one possibility.

In some embodiments, the unavailability information is for a single coexistence event over a single link, or it may be for multiple coexistence events involving multiple links.

In some embodiments, rather than sending the control message indicating the unavailability information in response to receiving the multi-user ICF, the wireless device may send an unsolicited unavailability announcement (UUA) to communicate the unavailability information. The UUA may be sent after establishing the first and second wireless connections and determining that a future unavailability event will occur, but may be sent without receiving the multi-user ICF at step 506 (e.g., it is unsolicited). In these embodiments, the UUA may be included in a management frame, where it may be processed at a higher layer than a control frame (e.g., higher than a MAC layer). This may be particularly useful for cross-link unavailability information, where unavailability information related to an unavailability event over a first link is transmitted over a different second link.

Thus, according to the method of FIG. 5, it may be possible to support use of unavailability information to manage the co-existence of multiple technologies (e.g., Wi-Fi and Bluetooth) and to manage Wi-Fi infrastructure and Wi-Fi peer-to-peer communication, for example to provide better handling of time shares between infrastructure and P2P or co-existence connections, among various possibilities. Such techniques may help reduce or avoid collisions, coexistence interference, unnecessary rate reduction from link adaptation, and/or provide any of a variety of other possible benefits, at least according to some embodiments.

Note that while at least some elements of the method of FIG. 5 are described in a manner relating to the use of communication techniques and/or features associated with IEEE 802.11 specification documents, such description is not intended to be limiting to the disclosure, and aspects of the method of FIG. 5 can be used in any suitable wireless communication system, as desired.

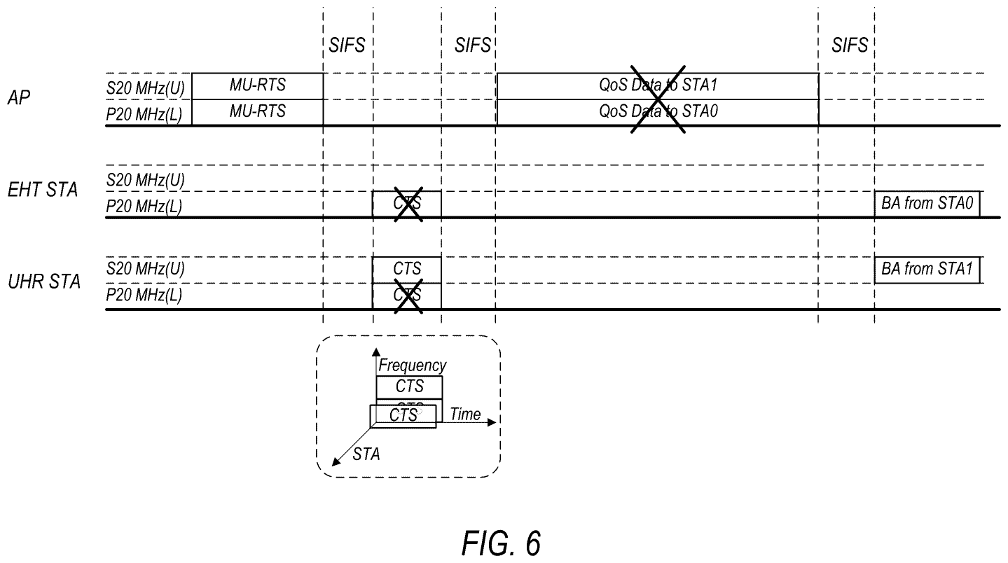

### FIGS. 6-14 and Additional Information

FIGS. 6-14 illustrate further aspects that might be used in conjunction with the method of FIG. 5. It should be noted, however, that the exemplary details illustrated in, and described with respect to, FIGS. 6-14 are not intended to be limiting to the disclosure as a whole: numerous variations and alternatives to the details provided herein below are possible and should be considered within the scope of the disclosure.

It is anticipated that coexistence features may be targeted toward UHR and future generations of Wi-Fi. Until UHR STAs (and later) are widely adopted, there are some options for the AP to handle associated HE/EHT and UHR STAs in a MU scenario so that it may receive unavailability information. For example, as a first option, the AP may schedule the HE/EHT and UHR STAs using transmission opportunities (TXOPs) by using the existing ICFs. Alternatively, the AP may schedule UHR STAs in a separate TXOP from HE/EHT STAs by using a new ICF for UHR STAs. Embodiments herein propose solutions for the UHR STA to indicate its unavailability information in the control response frames to MU-RTS and BSRP, which allows the AP to schedule HE/EHT and UHR STAs in a TXOP.

FIG. 6 illustrates coexistence information causing a conflict between an EHT STA and an UHR STA, according to some embodiments. In a MU sequence starting with MU-RTS/CTS, it may be desirable for the CTS frame content to change to convey the STA's unavailability information. Since different users have different coexistence unavailability information and CTS responses from different STAs may overlap, a collision of the CTSs with different content may result.

FIG. 7 illustrates a method to enhance the MU-RTS by utilizing the duration field to handle coexistence issues, according to some embodiments. The resource unit (RU) allocation field of MU-RTS may contain the RU location where CTS is sent in a non-HT DUP PPDU format, according to some embodiments. STAs with coexistence unavailability information may set the duration field to adjust the TXOP or indicate the unavailability start time. B15 in the Duration field may be used as an indicator of adjusting the TXOP (B15=0) or the unavailability start time (B15=1). UHR STAs that don't have coexistence info can set the network allocation vector (NAV) duration in the duration field when sending the CTS response. Since the Duration field indicates the unavailability timing, protection against legacy hidden nodes, e.g. 3rd party STAs, may be compromised. Embodiments herein address these and other concerns by providing TXOP protection.

FIG. 8 illustrates a method to improve protection for coexistence scenarios, where the STA which sends the unavailability information uses L-SIG for TXOP protection. The length field in L-SIG typically indicates the end of the PPDU duration, but this may be changed such that L-SIG indicates the length of the TXOP, in some embodiments. As illustrated, the STA may use the duration (DUR value below) field in the MU-RTS to derive the values in L-SIG field, using the parameters:

$$L\_LENGTH = ( DUR - SIFS - aPreambleLength - aPLCPHeaderLength ) * L\_DATARATE ,$$

$$and L\_DATARATE = 6 Mbps$$

The STA may set the L-SIG field of TB PPDU, which carries the PBT to protect the full TXOP. STA 1 in the example shown in FIG. 8 is the coexistence STA and sets the L-SIG length to protect the TXOP; similarly STA2 also sets the L-SIG length to protect the TXOP. If the CTS frame of STA1 and STA2 are different because of different duration field values, the CTS MAC frame decoding by 3rd party STA may fail, although the medium is still protected by L-SIG length.

If the EHT STA sets the L-SIG length to the PPDU duration, then the TXOP is not protected against OBSS STAs receiving only the CTS (different L-SIG lengths may cause an error because receiving STAs combine the CTS responses across the 40 MHz full band), so it may be desirable for the EHT STA to set the L-SIG length to protect the TXOP. For a HE/EHT STA, a FW update can handle setting the L-SIG length based on TXOP duration instead of PPDU duration. This is illustrated in FIG. 8.

FIG. 9 illustrates an example multi-user (MU) scenario in which a UHR STA refrains from transmitting a CTS message to implicitly indicate an upcoming coexistence event, according to some embodiments. In a multi-user (MU) scenario, it may be desirable to schedule both one or more UHR STAs and one or more HE/EHT STAs in single TXOP. The AP schedules STAs based on the resource unit (RU) allocations, and if a STA is experiencing or is expecting to experience a coexistence event, it may not respond with the CTS to implicitly indicate the upcoming coexistence event. The STA can potentially convey implicit coexistence information to the AP for rate adaptation. For the MU case, it may be desirable for the AP to refrain from degrading the rate for one or more STAs that are experiencing a coexistence event. This may assist the AP's scheduler and implementation, as in the MU case even if the AP receives accurate unavailability timing, it may not be feasible for the AP to take the unavailability information of the STA and adjust the PPDU/TXOP over-the-air. Advantageously, this may provide good TXOP protection against legacy STAs, and the absence of a CTS response indicates the unavailability of the STA, which can help the AP prevent an undesirable rate drop. However, these embodiments may not provide the exact unavailability timing, such as start time and/or duration. Note that how the AP uses the start time and unavailability timing in its scheduler may be unknown to the STA(s). For example, in a MU TXOP, when the AP receives unavailability information from different STAs, it may not be able to meet the requirements of each STA. The range may decrease because the receiver may not be able to combine the CTS across 20 MHz channels and may decode each 20 MHz channel separately. Alternatively, the AP may detect the presence of a CTS and combine the CTS(s) based on per-20 MHz packet detection, avoiding a decrease in range.

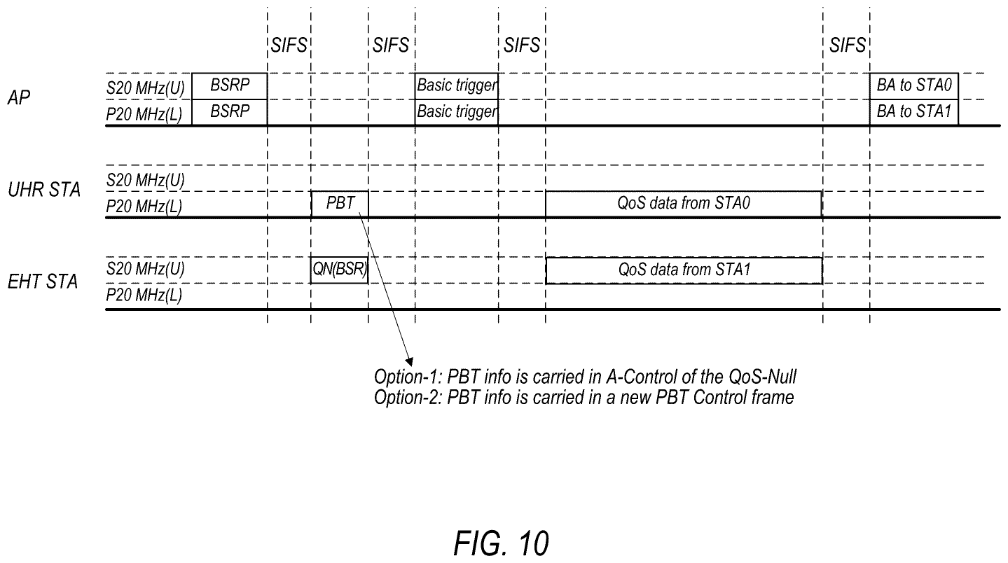

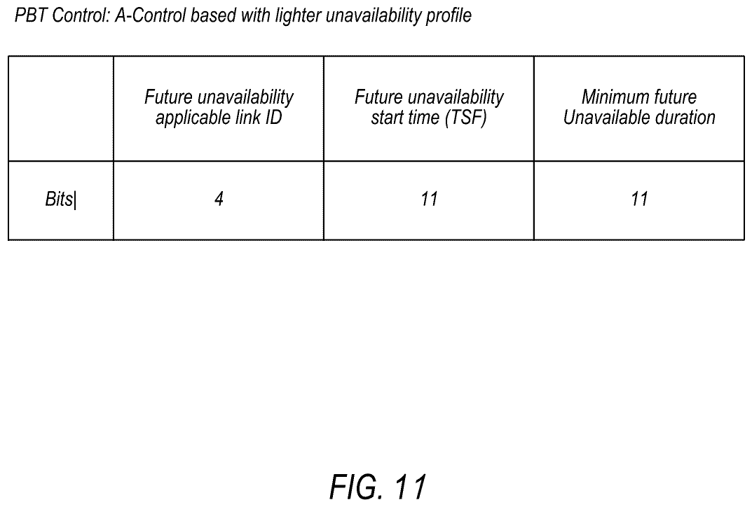

FIG. 10 illustrates an example method for using the BSR Control in the QoS-Null frame to send TB PPDU as a response to BSRP trigger frame, according to some embodiments. The initial control response (ICR) to the BSRP may carry the unavailability information. As a first option, a PBT Control may be defined (a new A-Control subfield) in the QoS-Null frame to be sent as a response to the BSRP. The QoS-Null may carry the PBT Control aggregated with other QoS-Null frames which carry the BSR Control in a TB PPDU. Advantageously, this may provide flexibility for the STA to indicate multiple light unavailability profiles in an ICR. As a second option, a PBT control frame may be defined in the ICR to the BSRP. This may allow the PBT control frame to carry a full unavailability profile to be aggregable with the QoS-Null frame (e.g. BSR Control) in a TB PPDU.

FIG. 11 illustrates an example of bit allocation for utilizing the A-Control subfield to communicate an unavailability profile and PBT control, according to some embodiments. There are 26 bits that can be used in the PBT Control subfield to indicate coexistence unavailability, which can be assigned as follows. The resolution may be defined as 64 μs, then by using 11 bits in A-Control, up to 2\hat{ }11*64 μs=131 ms may be covered. The unavailability duration may be able to be as short as 1.25 ms and as long as 2 seconds. If we define the resolution as 1.25 ms, then 11 bits can cover up to 2\hat{ }11*1.25 ms=2560 ms range. The remaining 4 bits can be used for the link ID. Depending on the AP MLD's capability, the cross-link unavailability information exchange among AP's of AP MLD may not be very fast, so it may not be suitable for UHR STA to indicate it in the ICR. Another advantage of A-Control signaling is that unavailability information can be easily used when the STA transmits UL PPDU or TB PPDU to the AP.

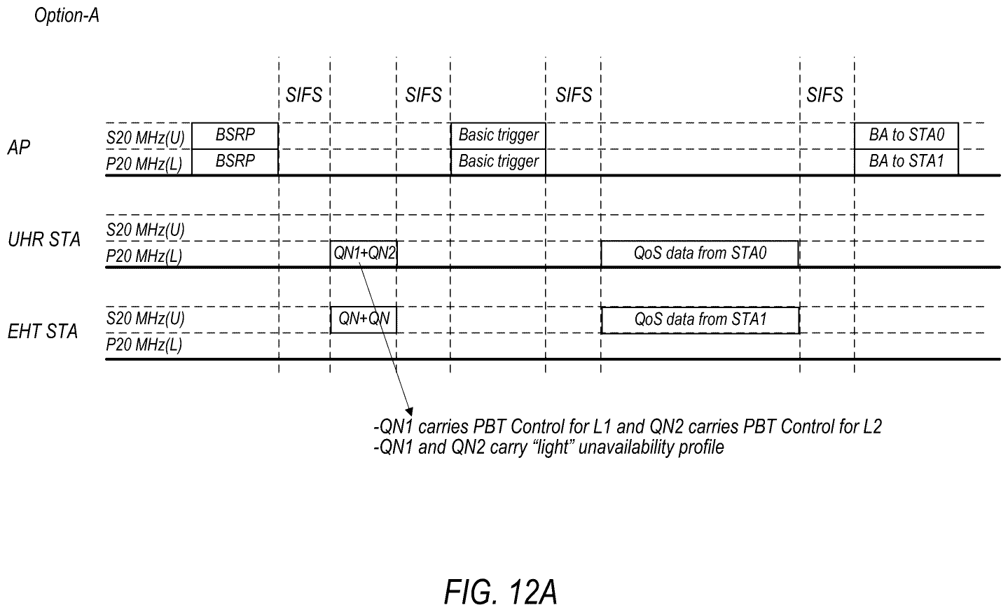

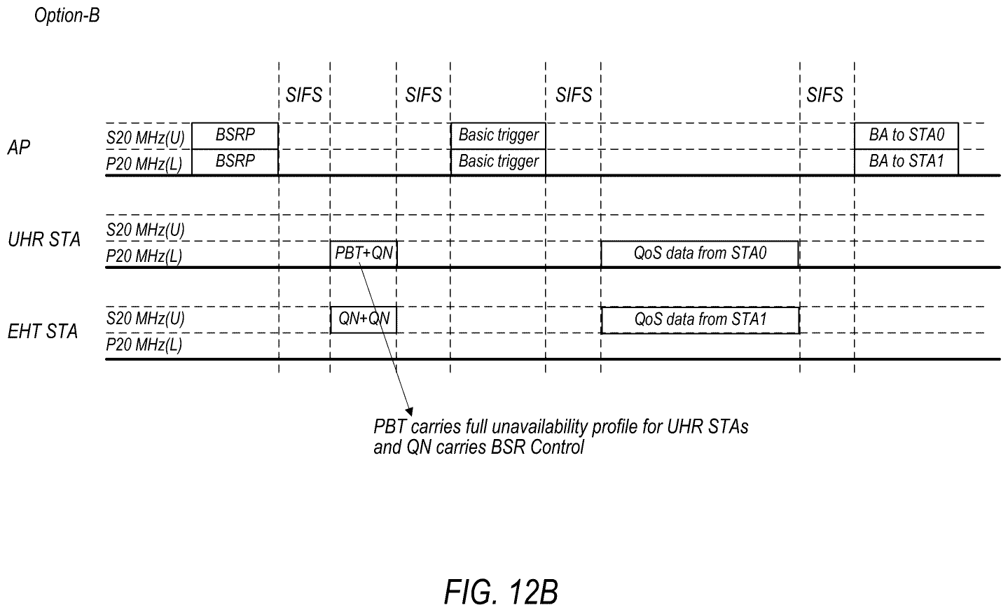

FIGS. 11A-B illustrates two options for utilizing BSR Control in QoS-Null that is aggregated with ACK/BA, according to some embodiments. Multiple QoS-Null frames can be aggregated in an aggregated media access control (MAC) packet data unit (AMPDU) carried in a TB PPDU. As a first option, shown in FIG. 12A, PBT Control (A-Control subfield) in the QoS-Null frame can be allowed to be aggregated with the BSR Control (A-Control subfield) in the QoS-Null frame in an AMPDU carried in a TB PPDU. The STA can indicate multiple light unavailability profiles for different links in different QoS-Null frames in an A-MPDU. The length of QoS-Null may be 34 bytes, in some implementations.

As a second option, shown in FIG. 12B, the PBT control frame can be defined and allowed to be aggregated with other frames in the control response. This allows the PBT frame with a full unavailability profile to be aggregable with QoS-Null frames in a TB PPDU.

In some embodiments, different options for the PBT control frame are proposed and may be utilized. For example, a first option (Option A) may use a full PBT control frame that can support independent coexistence events over each link with a maximum of 16 links. This may utilize 15+16*6=111 bytes. It may be desirable to report multiple coexistence events per link. In the case that the STA has more than one coexistence use cases running and may want to indicate all the events at the same time, the overhead increases significantly, which is not very efficient.

As a second option (Option B), a variable length PBT control frame may be used, similar to M-BA. It can support independent coexistence events over each link, which may depend on the non-AP MLD's enabled links. A one byte field may be used to indicate the number of events and links the non-AP MLD is reporting. This option utilizes 15+1+N*6 bytes, where N is the number of links. With N=3, this option results in an overhead of 34 bytes. Some embodiments may expand and/or modify the M-BA instead of the new variable length frame.

As a third option (Option C), a PBT control frame per event/link, aggregable in an A-MPDU, may be utilized. It can support independent coexistence events over each link by aggregating multiple PBT Control frames. This option utilizes (15+6) *N bytes, where N is the number of links. With N=3, this option results in an overhead of 63 bytes.

FIG. 14 illustrates an example PBT/UUA frame format, and a comparison of overhead values for the three different options described above, according to various embodiments.

In cross-link coexistence indication scenarios there is a cross-link processing time, and it may be desirable for the APs to use the management frame instead of the control frame to be able to process it at the higher layer instead of the lower media access control (LMAC) layer. If this is the case, the ICR frames can only carry the same link unavailability information and leave the cross-link unavailability information delivery to UUA (unsolicited PBT). Also due to the cross-link processing delay of the AP, the cross-link unavailability indication in ICR frames may not be as suitable. Both option B and C have less overhead and more flexibility in carrying multiple coexistence events. In addition, both options are variable length control frames. Note that while the signaling details that are discussed herein are in the context of MU, embodiments herein can be applied to the SU case as well.

If a STA uses PBT Control in QoS-Null, variable length PBT control frame, or PBT control frame per event/link(s) options, it can only send certain number of coexistence unavailability profiles in the TB PPDU based on the UL Length that the AP chooses in the BSRP. If a STA has multiple unavailability profiles, e.g. for different links or different coexistence events, it may not be able to fit everything within one TB PPDU, so it may send the rest of the info in the upcoming opportunity.

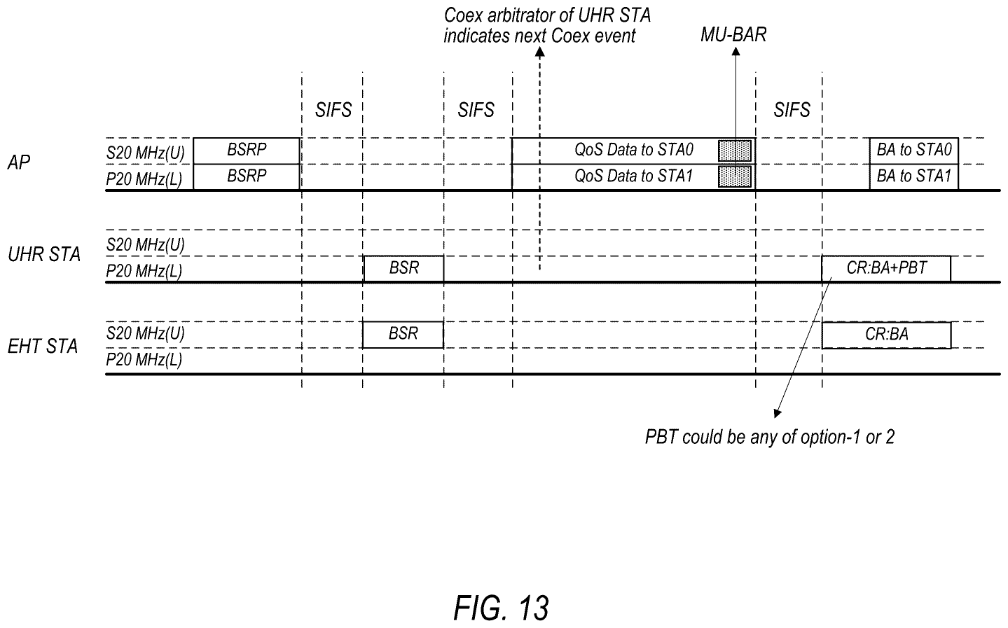

FIG. 13 illustrates a method for including the unavailability profile in control response block acknowledgment (CR/BA), according to some embodiments. Block acknowledgment (BA) and QoS-Null can be aggregated in the control response (CR) frame when the CR is sent in the TB PPDU format (QoS-Null with no ack policy). If a coexistence event from a coexistence arbitrator is determined in the middle of the TXOP, the STA can indicate the unavailability information to the AP in CR when responding to PPDU. The AP can aggregate an MU-BAR in A-MPDUs, which are sent to STA0 and STA1, and the STAs can indicate the unavailability information when responding with CR. This may be performed according to several options, in various embodiments. As a first option, the PBT Control subfield may be included in the QoS-Null, which can be aggregated with the BA frame. The STA can send its unavailability profile to the AP when transmitting BA to the DL PPDU. As a second option, similar to the BSR response in QoS-Null to BSRP, aggregation may be allowed of the PBT control frame with the BA and QoS-Null frames for UHR STAs, if the full unavailability profile is desired. In other words, the PBT control frame may be aggregated with the BA frame for UHR STAs.

Described embodiments enable STAs to deliver the unavailability information in MU TXOP. In some embodiments, both MU-RTS and BSRP can be used as the ICF to initiate the MU TXOP with the STAs with coexistence unavailability. Some embodiments enable the STAs to send the unavailability information in a control response frame to DL PPDU, e.g. BA.

In some embodiments, an AP can also solicit one or more associated non-AP STAs for their BSR(s) by sending a BSRP Trigger frame. The non-AP STA may respond with a solicited BSR as defined below.

The non-AP STA may include in the HE TB PPDU one or more QoS Null frames containing the QoS Control field(s) with Queue Size subfields for each of the traffic identifiers (TIDs) for which the non-AP STA has queue size to report to the AP, and/or the BSR Control subfield with the Queue Size All subfield indicating the queue size for the ACs.

The non-AP STA may not solicit an immediate response for the frames carried in the HE TB PPDU (e.g., the Ack Policy Indicator subfield of a QoS Null frame shall not be set to Normal Ack or Implicit BAR).

A non-AP STA that responds to a BSRP or BQRP Trigger frame addressed to it and that is not aggregated with any MPDUs that solicit an immediate acknowledgment may construct the A-MPDU carried in the HE TB PPDU as defined in 9-630 (A-MPDU contents in the data enabled no immediate response context) with the exception that the A-MPDU does not contain QoS Data frames. The non-AP STA may include in the AMPDU at least one QoS Null frame.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
by a wireless device:
establishing a first wireless connection using a first radio resource;
establishing a second wireless connection using the first radio resource;
receiving a multi-user initial control frame (ICF) from a wireless access point (AP) over the first wireless connection; and
based at least in part on receiving the multi-user ICF, transmitting a control response message to the wireless AP, wherein the control response message indicates unavailability information associated with the wireless device.

2. The method of claim 1,
wherein the unavailability information indicates a first time period of future unavailability for the wireless device on the first radio resource.

3. The method of claim 2,
wherein the indication of the first time period of future unavailability comprises one or more of:
a future unavailability start time;
a minimum future unavailability duration; or
a bitmap indicating a link associated with the future unavailability.

4. The method of claim 1,
wherein the control response message comprises a clear-to-send message,
wherein the method further comprises:
transmitting a legacy signal (L-SIG) message comprising a duration field to indicate a transmission opportunity (TXOP) duration,
wherein the control response message and the L-SIG message are both transmitted within a single Physical Layer Convergence Protocol (PLCP) Protocol Data Unit (PPDU).

5. The method of claim 1,
wherein the multi-user ICF comprises a multi-user request-to-send (MU-RTS), and
wherein the control response message comprises a clear-to-send message.

6. The method of claim 1,
wherein the multi-user ICF comprises a Buffer Status Report Poll (BSRP) message, and
wherein the control response message comprises a quality-of-service (QOS) null frame.

7. The method of claim 1,
wherein the unavailability information is indicated within an A-Control field of a quality-of-service (QOS) null frame, or
wherein the unavailability information is indicated by a probe-before-talk (PBT) frame.

8. The method of claim 1,
wherein the unavailability information is indicated by:
a full probe-before-talk (PBT) control frame; or
a variable length PBT control frame.

9. The method of claim 1,
wherein the unavailability information is for a single coexistence event associated with a single link.

10. The method of claim 1,
wherein the unavailability information is included in a block acknowledgment frame.

11. An apparatus, comprising:
at least one processor configured to cause a wireless device to:
establish a first wireless connection using a first radio resource;
establish a second wireless connection using the first radio resource;
receive a multi-user initial control frame (ICF) from a wireless access point (AP) over the first wireless connection; and
based at least in part on receiving the multi-user ICF, transmit a control response message to the wireless AP, wherein the control response message indicates unavailability information associated with the wireless device.

12. The apparatus of claim 11,
wherein the unavailability information indicates a first time period of future unavailability for the wireless device on the first radio resource,
wherein the indication of the first time period of future unavailability comprises one or more of:
a future unavailability start time;
a minimum future unavailability duration; or
a bitmap indicating a link associated with the future unavailability.

13. The apparatus of claim 11,
wherein the control response message comprises a clear-to-send message,
wherein the processor is further configured to cause the wireless device to:
transmit a legacy signal (L-SIG) message comprising a duration field to indicate a transmission opportunity (TXOP) duration,
wherein the control response message and the L-SIG message are both transmitted within a single Physical Layer Convergence Protocol (PLCP) Protocol Data Unit (PPDU).

14. The apparatus of claim 11,
wherein the multi-user ICF comprises a multi-user request-to-send (MU-RTS), and
wherein the control response message comprises a clear-to-send message.

15. The apparatus of claim 11,
wherein the multi-user ICF comprises a Buffer Status Report Poll (BSRP) message, and
wherein the control response message comprises a quality-of-service (QOS) null frame.

16. The apparatus of claim 11,
wherein the unavailability information is indicated within an A-Control field of a quality-of-service (QOS) null frame, or
wherein the unavailability information is indicated by a probe-before-talk (PBT) frame, wherein the PBT frame comprises a full PBT control frame or a variable length PBT control frame.

17. The apparatus of claim 11,
wherein the unavailability information is for a single coexistence event associated with a single link.

18. The apparatus of claim 11,
wherein the unavailability information is included in a block acknowledgment frame.

19. A wireless device, comprising:
one or more antennas;
a radio operably coupled to the one or more antennas; and
a processor operably coupled to the radio;
wherein the wireless device is configured to:
establish a first wireless connection using a first radio resource;
establish a second wireless connection using the first radio resource; and
transmit a control message over the first wireless connection, wherein the control message indicates unavailability information associated with the wireless device for the second wireless connection, wherein the unavailability information comprises an unsolicited unavailability announcement.

20. The wireless device of claim 19,
wherein the control message comprises a management frame.
